(19) United States
(12) Patent Application Publication
(10) Pub. No.: US 2003/0131606 A1
(43) Pub. Date: Jul. 17, 2003

(54) Gas turbine engine power boost using micro droplet liquid injection

(76) Inventors: James Carl Loebig, Indianapolis, IN (US); Baily Ramachandra Vittal, Carmel, IN (US)

Correspondence Address: Woodard, Emhardt, Naughton,, Moriarty and McNett LLP, Bank One Center/Tower, 111 Monument Circle, Suite 3700, Indianapolis, IN, 46204-5137, US

(21) Appl. No.: 10/295,402

(22) Filed: Nov. 15, 2002

Related U.S. Application Data
(63) Continuation of application No. 09/960,633, filed on Sep. 21, 2001, now abandoned.

(51) Int. Cl. F02C 3/30

(52) U.S. Cl. 60/775; 60/39.53

(57) ABSTRACT

The present invention contemplates a gas turbine engine compressor including a plurality of effervescent atomizers to inject a mixture of water and methanol into the compressor inlet. A plurality of droplets, preferably less than ten microns in size, travels through the inlet duct to the compressor. In one embodiment the plurality of effervescent atomizers are located around the circumference of the inlet duct and upstream of the compressor inlet and the injection occurs into a gas having a substantially ambient pressure.

### BACKGROUND OF THE INVENTION

The present invention relates generally to the injection of a liquid into the inlet air passing into an axial flow compressor to boost the power of a gas turbine engine. More particularly, in one embodiment, the present invention utilizes a plurality of effervescent atomizers to atomize a liquid into very small droplets, which are then injected into the inlet air stream of the gas turbine engine. Although the present invention was developed for use in gas turbine engines, certain applications may be outside this field.

Injection of a liquid, such as a mixture of water/methanol, into a gas turbine engine compressor has long been recognized as a way to increase the peak power that can be extracted from the engine. The injection of the water/methanol into the engine inlet air stream lowers the temperature of the air within the compressor. This permits a greater flow of air through the compressor. Also, the reduction in compressor discharge temperature translates into a reduction in compressor work required to get the same compression ratio. Alternatively, the air can be supplied at a higher pressure to the turbine and thus a greater pressure drop occurs across the turbine. The pressure drop across a turbine is a measure of available energy and with the increased pressure drop due to the injection of the water/methanol, a greater percentage of the available energy can be used for purposes of propulsion after the amount of energy necessary to drive the compressor have been extracted from the turbine.

One limitation associated with many water/methanol injection systems is that the injected droplets tend to impinge on the compressor casing thereby reducing the compressor casing temperature and causing the casing to shrink. The shrinkage of the compressor case may lead to rubbing of the compressor casing by a rotating compressor blade which will damage the casing by gouging the metal casing. The damage to the casing generally results in a gap being formed between the blade tip and the compressor case, which results in a permanent loss of compressor efficiency. One method of preventing blade rubs on water/methanol injected engines is to design the compressor with larger tip clearances between the blades and the casing. However, this lowers the compressor efficiency during non-injected operation of the engine.

Although the prior liquid injection systems of introducing a liquid into the compressor to boost peak power are steps in the right direction, there remains a need for an improved gas turbine engine power boost system. The present invention satisfies this need in a novel and unobvious way.

### SUMMARY OF THE INVENTION

One form of the present invention contemplates an apparatus, comprising: a gas turbine engine compressor having a compressor inlet; and, at least one effervescent atomizer having an atomizer outlet in fluid communication with the compressor inlet.

Another form of the present invention contemplates an apparatus, comprising: a gas turbine engine having an engine inlet, the gas turbine engine including a compressor, a turbine, and a combustor; a fluid communication passageway connecting the engine inlet with a remote inlet; and, a plurality of atomizers coupled to the gas turbine engine and in fluid communication with the passageway, each of the plurality of atomizers, comprising: an air chamber having a first inlet port adapted for receiving a pressurized gas; a tube with a plurality of perforations positioned within the air chamber, the tube has a second inlet port adapted for receiving a liquid and a discharge orifice for discharging a plurality of droplets, wherein the plurality of perforations are adapted to receive the pressurized gas from the air chamber and mix with the liquid within the tube; and the discharge orifice adapted to receive and discharge the liquid and pressurized gas from within the tube.

Yet another form of the present invention contemplates an apparatus, comprising: a gas turbine engine having an engine inlet, the gas turbine engine including an axial flow compressor with a compressor inlet, a turbine and a combustor; an inlet duct connecting the engine inlet with a remote inlet; and, a plurality of droplet delivery means for delivering droplets having a size less than about 10 microns to the inlet duct.

One aspect of the present invention contemplates a method for boosting the power of a gas turbine engine, comprising: providing an effervescent atomizer having a discharge orifice; passing a liquid into a first portion of the effervescent atomizer; passing a compressed gas into a second portion of the effervescent atomizer; feeding the compressed gas from the second portion into the liquid within the first portion of the effervescent atomizer; discharging a plurality of droplets from the discharge orifice into an inlet air stream directed towards an inlet of the compressor; flowing the plurality of droplets with the inlet air stream; and, evaporating at least a portion of the plurality of droplets.

One object of the present invention is to provide a unique gas turbine engine compressor with a liquid injection system.

Related objects and advantages of the present invention will be apparent from the following description.

### BRIEF DESCRIPTION OF THE DRAWINGS

FIG. 1 is a schematic illustration of a gas turbine engine.

FIG. 2 is a partial cross-section of a gas turbine engine.

FIG. 3 is an illustrative view of an effervescent atomizer of one embodiment of the present invention.

FIG. 4 is an illustrative view of an alternate embodiment of an effervescent atomizer comprising a portion of FIG. 2.

FIG. 5 is a tube comprising a portion of the effervescent atomizer of FIG. 4.

FIG. 6 is a cross-sectional view of the tube of FIG. 5.

FIG. 7 is a schematic view of a plurality of effervescent atomizers positioned adjacent the gas turbine engine flow path.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

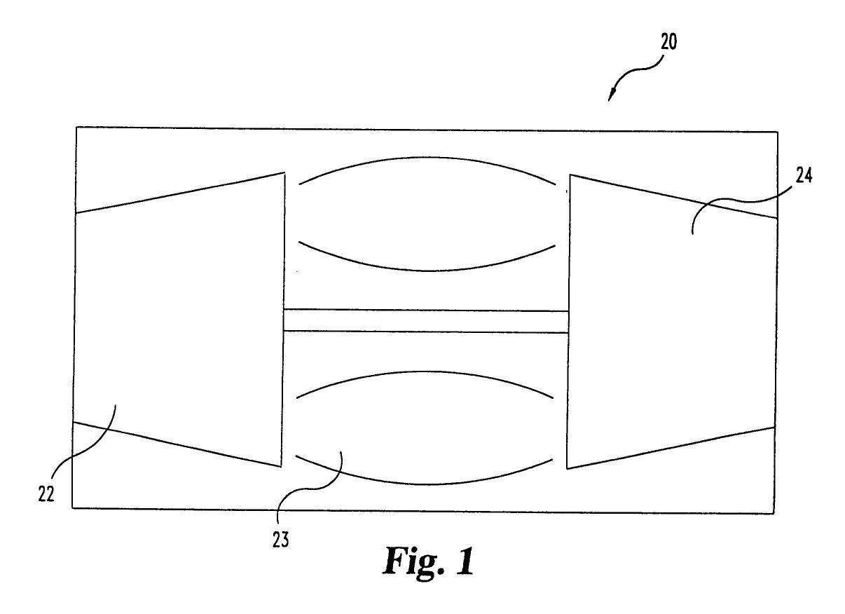

Referring to FIG. 1, there is illustrated a schematic representation of a gas turbine engine 20 which includes a compressor section 22, a combustor section 23, and a turbine section 24 that are integrated together to produce an aircraft flight propulsion engine. One alternate form of a gas turbine engine includes a compressor, a combustor, a fan section, and a turbine that have been integrated together to produce an aircraft flight propulsion engine, which is generally referred to as a turbo-fan. The term aircraft is generic and includes helicopters, airplanes, and missiles, unmanned space devices and any other substantially similar devices. It is important to realize that there are multitudes of ways in which the gas turbine engine components can be linked together. Additional compressors and turbines could be added with intercoolers connecting between the compressors and reheat combustion chambers could be added between the turbines.

A gas turbine engine is equally suited to be used for an industrial application. Historically, there has been widespread application of industrial gas turbine engines, such as pumping sets for gas and oil transmission lines, electricity generation, and naval propulsion.

The compressor section 22 includes a rotor having a plurality of compressor blades coupled thereto. The rotor is affixed to a shaft that is rotatable within the gas turbine engine 20. A plurality of compressor vanes are positioned within the compressor section 22 to direct the fluid flow relative to the compressor blades. Turbine section 24 includes a plurality of turbine blades that are coupled to a rotor disk. The rotor disk is affixed to the shaft, which is rotatable within the gas turbine engine 20. Energy extracted in the turbine section 24 from the hot gas exiting the combustor section 23 is transmitted through the shaft to drive the compressor section 22. Further, the turbine section 24 provides power to an output shaft, which is utilized to drive a propulsion device, such as a fan or propeller in an aircraft. Further details related to the principles and components of a conventional gas turbine engine will not be described herein as they are believed known to one of ordinary skill in the art.

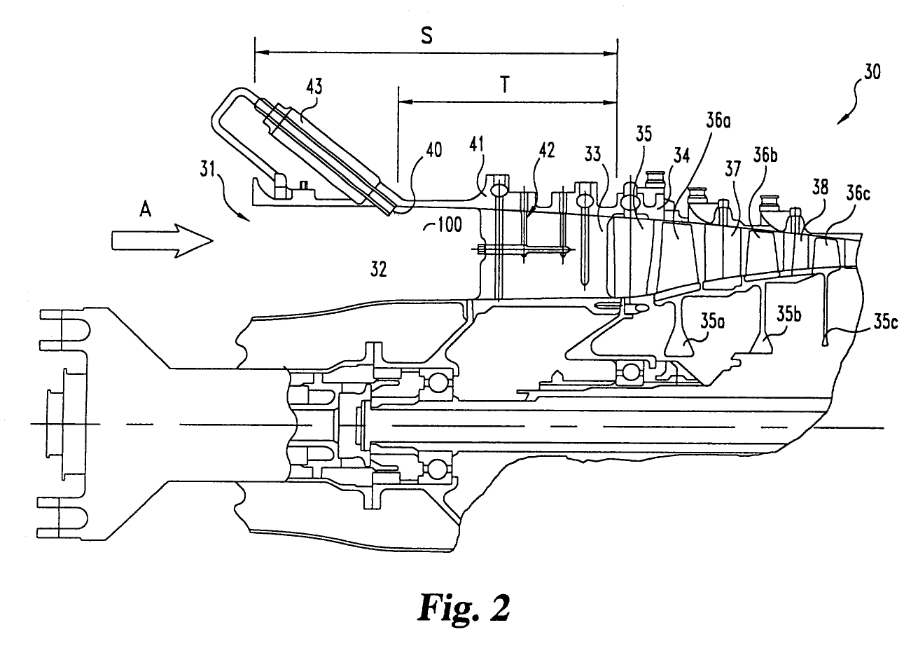

With reference to FIG. 2, there is illustrated a portion of a gas turbine engine 30. The present invention is not intended to be limited to the specific gas turbine engine shown, and other gas turbine engines known to one of ordinary skill in the art are contemplated herein. A remote inlet 31 is coupled to and placed in fluid communication with the gas turbine engine 30 by a fluid passageway 32. In one embodiment the remote inlet 31 is spaced a distance ‘S’ from the compressor inlet 33. An effervescent atomizer 43 is positioned to atomize a liquid and discharge a plurality of droplets 100 into the fluid passageway 32, and more preferably a plurality of effervescent atomizers are spaced around the circumference of the passageway to discharge a plurality of droplets into the passageway 32. The pressure within the passageway 32 adjacent the effervescent atomizer is a relatively low-pressure environment, and near ambient in one embodiment. The plurality of droplets generally have a size less than about 100 microns, and more preferably have a size less than about 10 microns. The plurality of droplets is injected from the plurality of effervescent atomizer into the air stream represented by arrow ‘A’. Evaporation of a portion/fraction of the plurality of droplets occurs as the air stream flows within the fluid passageway 32 prior to entering the compressor at the compressor inlet 33. In one embodiment the fraction/portion of the liquid evaporated prior to reaching the compressor inlet 33 is within a range of about 5-10 percent, however other fractions/portions are contemplated herein. Further, the remaining portion/fraction of the plurality of droplets continues to be evaporated within the compressor 34. In a preferred embodiment the working fluid exiting the compressor and passing to the combustor has had about ninety percent of the liquid evaporated, and more preferably has had one hundred percent of the liquid evaporated. However, other fractions/portions are contemplated herein.

The discharge orifice 40 is spaced a distance ‘T’ from the compressor inlet 33 and positioned in fluid communication with the compressor inlet. In one embodiment the distance ‘T’ is selected to allow sufficient residence time for the plurality of droplets flowing with the air stream within the fluid passageway 32 for evaporation of a portion of the droplets to occur. The distance ‘T’ in one embodiment is within the range of about 5-30 inches, and in another embodiment is about five inches. More preferably, the distance ‘T’ is about thirty inches. In an alternate embodiment the discharge orifice 40 is located so as to inject the plurality of droplets into the compressor inlet, without traveling through an inlet duct/passageway leading to the compressor inlet.

The compressor inlet 33 defines the transition from the inlet duct 41 to the compressor 34. The configuration and geometry of the duct 41 is not intended to be limited to that shown in the drawings, and other duct sizes, geometries and lengths are contemplated herein. Further, duct 41 has been illustrated with a pressure sensing system 42 disposed therein, however in alternate embodiments this equipment is not present or has been replaced with other types of sensors.

The compressor 34 is a multi-stage axial flow compressor having a plurality of variable inlet guide vanes 35. The number of stages of the multi-stage compressor is preferably within a range of about 1-40. Each of the illustrated stages includes a rotor disk 35a, 35b, and 35c with a plurality of compressor blades 36a, 36b, and 36c coupled to the respective rotor disk. Positioned between the stages of the compressor are a plurality of inter-stage vanes 37 and 38.

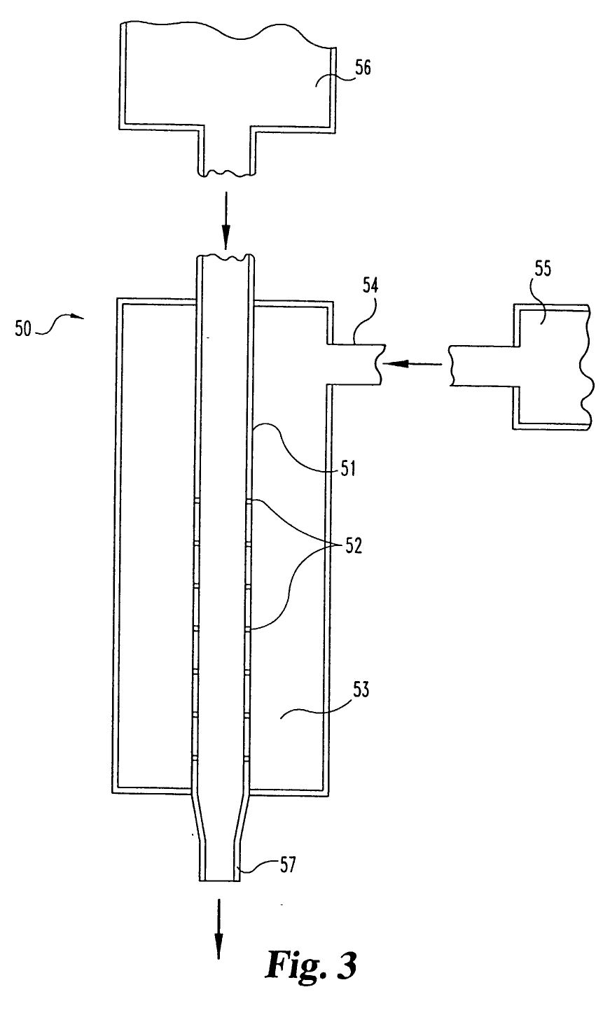

With reference to FIG. 3, there is illustrated an effervescent atomizer 50 that is substantially similar to the effervescent atomizer 43. The design and fabrication of effervescent atomizers is believed generally known to a person skilled in the art, and are believed available from Purdue University. The effervescent atomizer 50 has an inner tube 51 including a plurality of perforations 52. The inner tube 51 is positioned within a chamber 53 and connected to and in fluid communication with a liquid supply 56. In a preferred embodiment the liquid within the liquid supply 56 is selected from water and a mixture of water and an alcohol, however other liquids and combinations of liquids are contemplated herein. More specifically, the liquid preferably is chosen to be water or a mixture of methanol and water. The chamber 53 has a pressurized gas inlet port 54 that is coupled to a supply 55 of pressurized gas. In one embodiment the pressurized gas is defined by air, however other gases and combinations of gases are contemplated herein, including but not limited to CO2 and O2. Further, the pressure of the gas within the chamber 53 is greater than the pressure of the liquid within the inner tube 51. Therefore the pressurized gas passes from the chamber 53 through the plurality of perforations 52 into the inner tube 51 where it mixes with the liquid within the tube.

The tube 51 includes a discharge orifice 57 for discharging the liquid and gas from the tube into the passageway 32 leading to the compressor inlet 33. Upon being discharged from the orifice 57 the pressurized gas expands and shears the liquid into small droplets. Parameters such as the length of the inner tube 51, the size and number of perforations 52, the pressure of the input fluids, and the orifice 57 diameter are varied to obtain a desired droplet size.

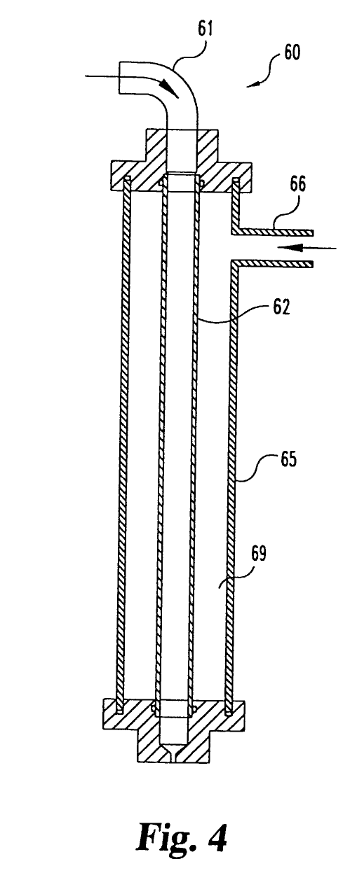

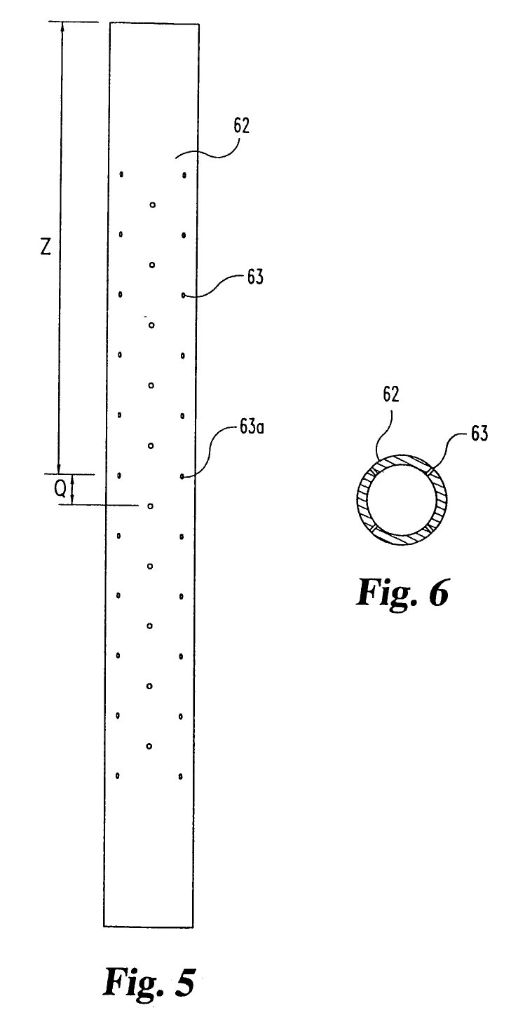

With reference to FIGS. 4-6, there is illustrated another embodiment 60 of an effervescent atomizer substantially similar to the atomizers 33 and 50. The effervescent atomizer 60 has a liquid inlet 61 in fluid communication with a tube 62. Tube 62 has a plurality of perforations 63 formed therethrough for the passage of a pressurized gas into the liquid within the tube 62. Further, the tube 62 is positioned within the chamber 65 and spaced from the wall member 69. The pressurized gas is introduced into a chamber 65 through an inlet 66. A discharge orifice 67 positioned in fluid communication with the tube 62 allows the passage of the liquid and gas from the tube 62. Upon being discharged from the orifice the liquid is sheared into a plurality of small droplets by the expanding gas.

While the design and fabrication of an effervescent atomizer are believed known to one of ordinary skill in the art, an example of a preferred embodiment will now be set forth with the assistance of FIGS. 4-6. However, the present invention is not intended to be limited to the specific embodiment illustrated, and other effervescent atomizers are contemplated herein. In a preferred embodiment the tube 62 is cylindrical in shape and has a length of about 6.338 inches, and a set of perforations 63a formed at the midpoint of the length of the tube 62, and indicated by ‘Z’. The perforations 63 are arranged in sets, which are spaced about 0.197 inches from the center of the prior set of perforations and indicated as being spaced by the indicator ‘Q’. In the preferred embodiment there are four perforations in each set, and the perforations are spaced about ninety degrees apart. The perforations 63 in adjacent sets are offset from one another by about 45 degrees. More preferably, there are 21 sets of perforations 63 formed in the tube 62, and with 4 perforations per set there are 84 holes in tube 62 for the passage of compressed gas. In one embodiment the perforations 63 are circular in shape and have a diameter of about 0.020 inches, which corresponds to a number 76 drill bit. Further, the tube has an inner diameter of 0.375 inches and an outer diameter of 0.500 inches. The chamber 65 has a circular shape with an internal diameter of about 1.50 inches, and a length of about 6.00 inches.

In one embodiment the discharge orifice has a diameter of about 1 millimeter, and more preferably has a diameter of about 3 millimeters. The liquid is delivered from the liquid supply at a rate of about 1.5 gallons per minute, and the pressurized gas is delivered from the pressurized gas supply at a rate of about 8.3 standard cubic feet per minute and at a pressure of about 250 psia. The resulting fluid discharge from the orifice has a mass flow rate of about 93 grams/sec and a pressure of about 14.7 psia. This is only one example of an effervescent atomizer and other atomizers having different flow rates, sizes, geometry, orifice diameters, and hole sizes are contemplated herein.

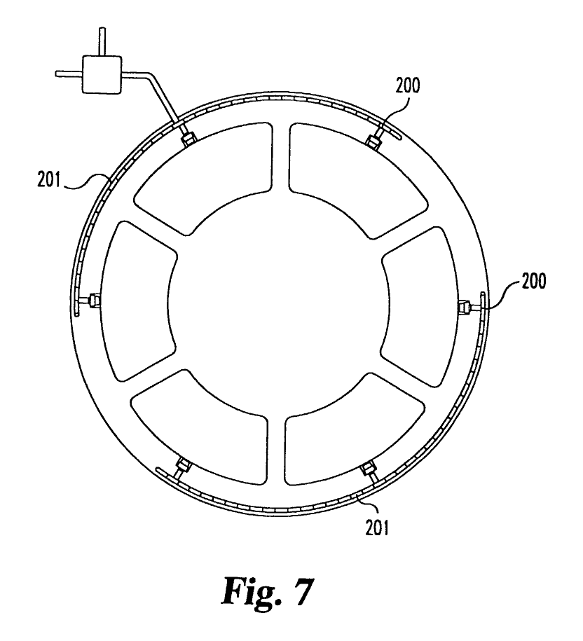

With reference to FIG. 7, there is illustrated a schematic representation of a plurality of effervescent atomizers 200 positioned around the circumference of the compressor inlet flow path. The plurality of effervescent atomizers 200 are substantially similar to the effervescent atomizers discussed previously herein. Further, in one embodiment the plurality of atomizers is spaced 60 degrees apart and positioned to deliver a uniform circumferential distribution of liquid droplets. A series of fluid distribution manifolds 201 and 202 are utilized to supply the liquid to the plurality of effervescent atomizers 200, and a series of manifolds (not illustrated) are utilized to supply the pressurized gas to the plurality of effervescent atomizers.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. An apparatus, comprising:
a gas turbine engine compressor having a compressor inlet; and
at least one effervescent atomizer having an atomizer outlet in fluid communication with said compressor inlet.

2. The apparatus of claim 1:
which further includes a liquid supply in fluid communication with said at least one atomizer, and wherein said at least one atomizer is adapted to receive a liquid from said liquid supply and atomize the liquid passing through said atomizer outlet into a plurality of droplets having a size less than about 100 microns.

3. The apparatus of claim 2, wherein said plurality of droplets having a size less than about 10 microns.

4. The apparatus of claim 1, which further includes an inlet duct coupled to said compressor and defining a passageway in fluid communication with said compressor inlet, and wherein said at least one atomizer is positioned to discharge a fluid into said passageway.

5. The apparatus of claim 4:
which further includes a liquid supply in fluid communication with said at least one atomizer, and wherein said at least one atomizer is adapted to receive a liquid from said liquid supply and atomize the liquid passing through said atomizer outlet into a plurality of droplets; and
wherein said atomizer outlet is positioned to discharge the plurality of droplets into said passageway at a distance from said compressor inlet.

6. The apparatus of claim 5, wherein a portion of the plurality of droplets are evaporated as they pass along said passageway over said distance.

7. The apparatus of claim 5, wherein said passageway has a pressure adjacent said atomizer outlet that is near ambient.

8. The apparatus of claim 1, wherein said compressor is an axial flow compressor, and wherein said at least one effervescent atomizer defines a plurality of effervescent atomizers.

9. The apparatus of claim 8, wherein said plurality of effervescent atomizers defines a quantity of atomizers within a range of about 4-12.

10. The apparatus of claim 1, which further includes a liquid supply disposed in fluid communication with said at least one atomizer, and wherein said liquid supply contains a quantity of water.

11. The apparatus of claim 1, which further includes a liquid supply disposed in fluid communication with said at least one atomizer, and wherein said liquid supply contains a quantity of water and methanol.

12. The apparatus of claim 1, wherein said compressor forms a portion of an aircraft engine.

13. The apparatus of 1:
wherein said at least one effervescent atomizer defines a plurality of effervescent atomizers;
which further includes a liquid supply in fluid communication with said plurality of effervescent atomizers, and wherein each of said plurality of effervescent atomizers is adapted to receive a liquid from said liquid supply and atomize the liquid passing through said atomizer outlet into a plurality of droplets having a size less than about 100 microns; and
which further includes an inlet duct coupled to said compressor and defining a passageway in fluid communication with said compressor inlet, and wherein said plurality of effervescent atomizers are positioned to discharge the plurality of droplets into said passageway, and wherein at least a portion of the plurality of droplets evaporate as they pass along said passageway toward said compressor inlet.

14. The apparatus of claim 13, wherein said compressor is an axial flow compressor, and wherein the plurality of droplets have a size generally less than about 10 microns.

15. The apparatus of claim 14, wherein the liquid is selected from water or water and methanol.

16. An apparatus, comprising:
a gas turbine engine having an engine inlet, said gas turbine engine including a compressor, a turbine, and a combustor;
a fluid communication passageway connecting said engine with a remote inlet; and
a plurality of atomizers coupled to said gas turbine engine and in fluid communication with said passageway, each of said plurality of atomizers, comprising:
an air chamber, said air chamber has a first inlet port adapted for receiving a pressurized gas;
a tube with a plurality of perforations positioned within said air chamber, said tube has a second inlet port adapted for receiving a liquid and a discharge orifice for discharging a plurality of droplets, wherein said plurality of perforations are adapted to receive the pressurized gas from said air chamber and mix with the liquid within said tube; and
said discharge orifice adapted to receive and discharge the liquid and pressurized gas from within said tube.

17. The apparatus of claim 16, wherein each of said plurality of atomizers atomize the liquid, and wherein the plurality of droplets are generally less than about 100 microns.

18. The apparatus of claim 17, wherein the plurality of droplets are generally less than about 10 microns.

19. The apparatus of claim 16, which further includes an inlet duct extending from said remote engine inlet to said engine inlet and wherein said inlet duct defines said passageway;

20. The apparatus of claim 19, wherein said compressor is a multi-stage axial flow compressor.

21. The apparatus of claim 16, which further includes a liquid supply connected to said second inlet port, and wherein the liquid is selected from the group consisting of water and the combination of water and methanol, and wherein the pressurized gas is air.

22. An apparatus, comprising
a gas turbine engine having an engine inlet, said gas turbine engine including an axial flow compressor with a compressor inlet, a turbine and a combustor;
an inlet duct connecting said engine inlet with a remote inlet; and
a plurality of droplet delivery means for delivering droplets having a size less than about 10 microns to said inlet duct.

23. The apparatus of claim 22, wherein said plurality of droplet delivery means deliver a substantially uniform droplet distribution to said compressor inlet.

24. The apparatus of claim 22, wherein the pressure within the inlet duct adjacent said plurality of droplet delivery means is not substantially different than the ambient pressure at said remote inlet.

25. The apparatus of claim 22, wherein each of said plurality of droplet delivery means is identical, and wherein the droplets include water.

26. The apparatus of claim 25, wherein air is used as an aiding fluid in said plurality of droplet delivery means.

27. A method for boosting the power of a gas turbine engine, comprising:
providing an effervescent atomizer having a discharge orifice;
passing a liquid into a first portion of the effervescent atomizer;
passing a compressed gas into a second portion of the effervescent atomizer;
feeding the compressed gas from the second portion into the liquid within the first portion of effervescent atomizer;
discharging a plurality of droplets from the discharge orifice into an inlet air stream directed towards an inlet of the compressor;
flowing the plurality of droplets with the inlet air stream; and
evaporating at least a portion of the plurality of droplets.
